(19) United States
(12) Patent Application Publication
(10) Pub. No.: US 2021/0019324 A9
(43) Pub. Date: Jan. 21, 2021

(54) SYSTEM FOR EFFICIENT INFORMATION EXTRACTION FROM STREAMING DATA VIA EXPERIMENTAL DESIGNS

(71) Applicant: TIBCO Software Inc., Palo Alto, CA (US)

(72) Inventors: Thomas HILL, Tulsa, OK (US); Michael O'Connell, Durham, NC (US)

(21) Appl. No.: 16/501,120

(22) Filed: Mar. 11, 2019

Related U.S. Application Data
(63) Continuation-in-part of application No. 15/941,911, filed on Mar. 30, 2018, now Pat. No. 10,248,110.
Application No. 15/941,911 is a continuation-in-part of application No. 14/690,600, filed on Apr. 20, 2015, now Pat. No. 9,952,577.
Application No. 14/690,600 is a continuation-in-part of application No. 15/237,978, filed on Aug. 16, 2016, now Pat. No. 10,386,822.
Application No. 15/237,978 is a continuation-in-part of application No. 15/214,622, filed on Jul. 20, 2016.
Application No. 15/214,622 is a continuation-in-part of application No. 15/186,877, filed on Jun. 20, 2016, now Pat. No. 10,839,024.
Application No. 15/186,877 is a continuation-in-part of application No. 15/139,672, filed on Apr. 27, 2016, now Pat. No. 10,467,226.
Application No. 15/139,672 is a continuation-in-part of application No. 15/067,643, filed on Mar. 11, 2016, now Pat. No. 10,671,603.
Application No. 15/067,643 is a continuation-in-part of application No. 14/826,770, filed on Aug. 14, 2015, now Pat. No. 10,649,973.
Application No. 14/826,770 is a continuation-in-part of application No. 14/666,918, filed on Mar. 24, 2015, now Pat. No. 10,007,681.
Application No. 14/666,918 is a continuation-in-part of application No. 14/665,292, filed on Mar. 23, 2015, now Pat. No. 10,481,919.

(51) Int. Cl. G06F 16/25; G06F 16/2455

(52) U.S. Cl. CPC G06F 16/254; G06F 16/24568

(57) ABSTRACT

A system, method, and computer-readable medium for extracting the samples from big data to extract most information about the relationships of interest between dimensions and variables in the data repository. More specifically, extracting information from lame data repositories follows an adaptive process that uses systematic sampling procedures derived from optimal experimental designs to target from a large data set specific observations with information value of interest for the analytic task under consideration. The application of adaptive optimal design to guide exploration of large data repositories provides advantages over known big data technologies.

### BACKGROUND OF THE INVENTION

### 1. Field of the Invention

The present invention relates to information handling systems. More specifically, embodiments of the invention relate to extraction of information for large data repositories

### 2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to use information handling systems to collect and store large amounts of data. However, a mismatch exists with respect to technologies to collect and store data, vs. available technologies and capabilities to extract useful information from large data within a reasonable amount of time. It is known to deploy technologies such as Hadoop and HDFS for large and unstructured data storage across various industries. Many technologies are being developed to process large data sets (often referred to as “big data”, and defined as an amount of data that is larger than what can be copied in its entirety from the storage location to another computing device for processing within time limits acceptable for timely operation of an application using the data), however, the ability to collect and store data often outpaces the ability to process all of the data.

Edit this Section to stress streaming-data-applications, as “infinite data.” Provide as examples—Automated manufacturing systems—Automated process monitoring systems. Make reference to “big data” and (perhaps) state the point that streaming data is infinite data, and hence, Streaming Data is a special case of (infinite) big data. Then the definition of “bit data” as stated will apply.

Most known Big Data technologies focus on how to process and analyze all data within a large data repository. This approach is bound to become inefficient or might even fail for practical applications because data volumes can and usually will grow at a very fast rate while the information contained in the data will not.

### SUMMARY OF THE INVENTION

A system, method, and computer-readable medium are disclosed for extracting the samples from big data to extract most information about the relationships of interest between dimensions and variables in the data repository. More specifically, extracting information from large data repositories follows an adaptive process that uses systematic sampling procedures derived from optimal experimental designs to target from a large data set specific observations with information value of interest for the analytic task under consideration. The application of adaptive optimal design to guide exploration of large data repositories provides advantages over known big data technologies.

The preceding paragraph includes the notation: . . . continuously generates values for 1000 parameters . . .

For example, an example process generates values for 1000 parameters (x1, . . . , x1000) every second. Further, the values for 10 of these parameters interact in a complex fashion to affect some important outcome value y of interest, so that y is a function of 10 unknown parameters xi through xq, or y=f(xi, xj, xk, . . . , xq). In this example, the information available in the 1000 input parameters for predicting y is finite, and regardless of how much data is collected for x and y, this information will not change. Therefore, by applying a strategy to query the very large dataset for the specific observations that are most diagnostic with respect to estimation procedures for approximating from the data the function y=f(xi, xj, xk, . . . , xq) significant effort and time can saved.

The preceding paragraph should be edited to include the notation: to specifically filter the continuously streaming data for the specific observations that are most diagnostic . . . .

Accordingly applying adaptive sampling operations allow adaptive optimal experimental design operations devised for manufacturing to be used to implement an efficient information gathering strategy against very large data repositories.

The preceding paragraph should be edited to include the notation: . . . continuously streaming

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of an adaptive sampling environment.

FIG. 3 shows a flow chart of the operation of an adaptive sampling system.

FIG. 4 shows a user interface using sliders to specify such a region-of-interest.

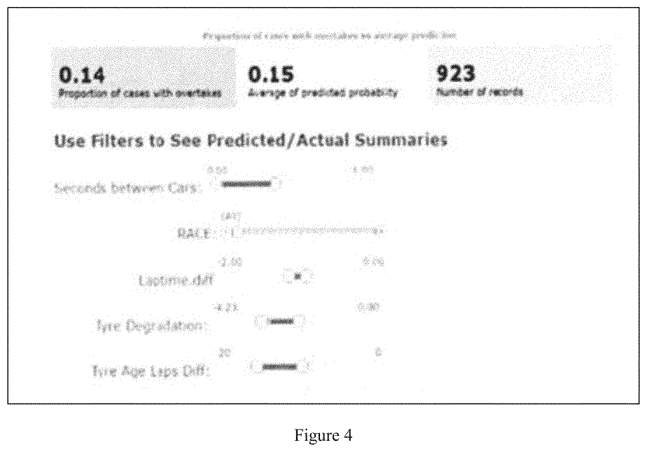

FIG. 5 shows a summary of components and flow of data and information.

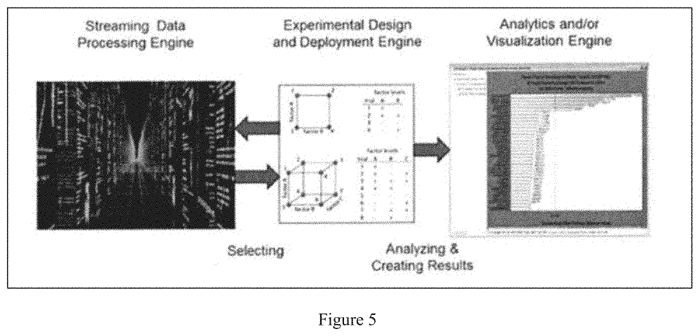

FIG. 6 shows the summary of components and flow of data and information along with commentary.

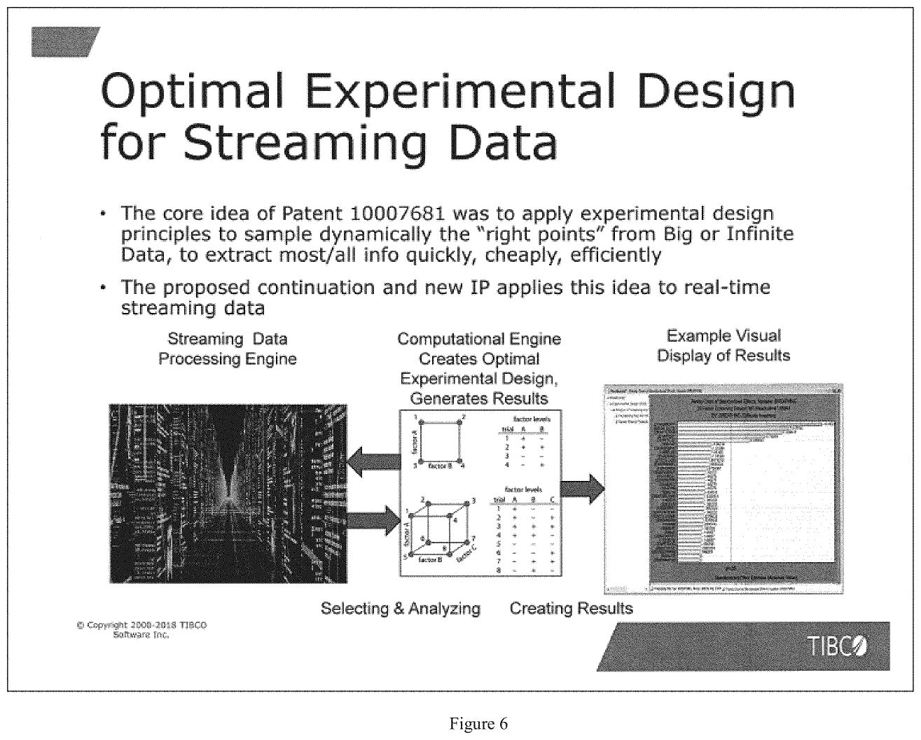

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

This entire section—detailed description—must be modified to include a streaming (event) data processing system. All references to big data storage to be replaced with “continuously streaming data.” But most of the details can remain. We should reflect here the back-and-forth between the streaming-data processing engine (that “listens” and selects diagnostic observations) and the computations and displays results, and also updates the experimental design matrix.

Rewrite Abstract to stress streaming data, e.g., A system, method, and computer readable medium for extracting the specific data from continuously streaming data to extract . . . ? More specifically, the extracting information from continuously streaming data follows an adaptive process involving a streaming-data-processing engine that continuously looks for specific observations consistent with a systematic sampling procedures derived from . . . ”

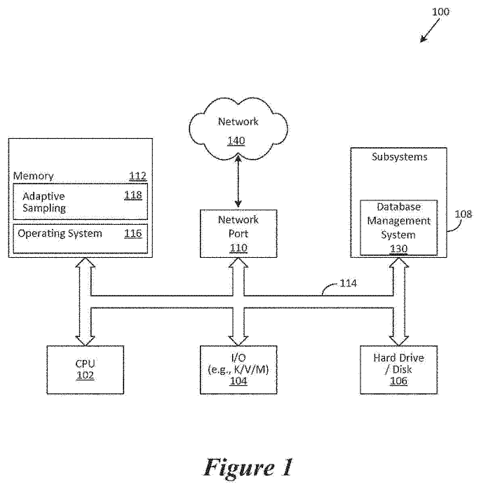

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise an adaptive sampling module 118. Also, in certain embodiments, the information handling system 100 further includes a database management system 130 for accessing and interacting with various data repositories such as big data repositories.

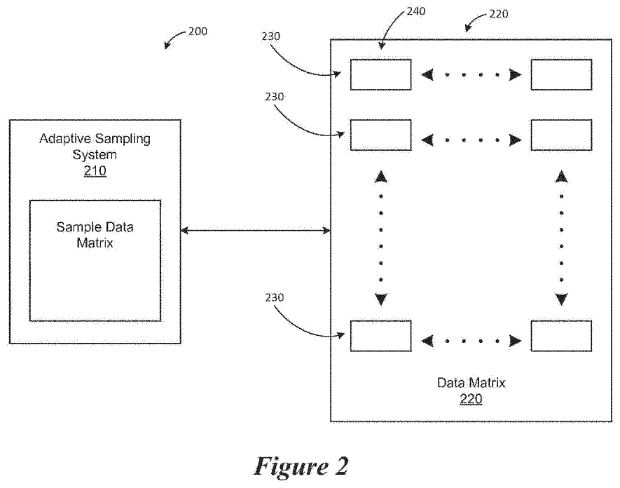

Referring to FIG. 2 a block diagram of an adaptive sampling environment 200 is shown. More specifically, the adaptive sampling environment 200 includes an adaptive sampling system 210 which interacts with a data matrix 220. The data matrix 220 includes n rows 230 by m columns 240 of values of explanatory variables. The rows 230 represent cases of the data matrix and the columns 240 represent variables of the data. The adaptive sampling system 210 extracts from that data matrix as much information as possible for the prediction of some variable y, or for other analytic tasks.

The adaptive sampling system 210 determines an arrangement of specific observations chosen into a sample data matrix X′. The accuracy of any linear model (which may be considered the information) for the adaptive sampling system 210 predicting y depends on the specific observations chosen into the sample data matrix X′ (which may be referred to as Design Matrix X). By using optimal experimental design to select a best sample Design Matrix XF from a much larger data matrix X, the computational effort involved in extracting information from the data matrix X is independent of the size of X (i.e., the size of the actual big data) and is only dependent of the complexity of the specific prediction models to be considered.

The details provided in paragraphs 17 to 26 still apply, except that they should be written to talk about streaming data, not data there one-time-extracted from a Big Data repository.

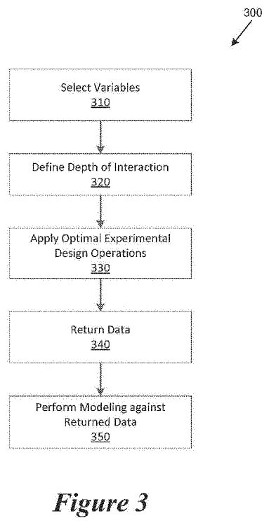

Referring to FIG. 3, a flow chart of the operation 300 of an adaptive sampling system 210 is shown. In certain embodiments, the adaptive sampling system 210 includes some or all of the adaptive sampling module 118.

The operation of the adaptive sampling system starts at step 310 by the adaptive sampling system 210 selecting variables X from a big-data-repository. Next, at step 320, the adaptive sampling system 210 defines the depth of interactions that are of interest. Next at step 330, the adaptive sampling system 210 applies optimal experimental design operations to the selected variables and the defined depth of interactions. Return data to adaptive sampling system 210 based upon optimal experimental design operations at step 340. Next, at step 350, once data are returned to the adaptive sampling system, subsequent modeling is performed against the much smaller sample matrix X′.

When defining the depth of interactions that are of interest, the adaptive sampling system 210 considers a plurality of issues. More specifically, the adaptive sampling system determines whether to only consider the information that can be extracted using each parameter. Additionally, the adaptive sampling system 210 determines whether to consider certain interactions such as interactions of the type X1*X2, X2*X3, . . . , Xi*Xj. The example interaction type shows two-way interactions or the multiplications of two design “vectors.” However, the adaptive sampling system 210 can also define three- or higher-way interactions as well.

Additionally, the adaptive sampling system 210 determines the types of variable to consider. The variables may be continuous variables, rank-ordered variables or discrete variables. An example of a continuous variable is age, an example of rank-ordered variable is a grade received in a class and an example of a discrete variable is gender. When defining a depth of interaction for continuous variables and rank-ordered variables, the adaptive sampling system 210 identifies high (or maximum) and low (or minimum) category values and then divides a range of values into predefined categories (e.g., high and low, high, medium and low, etc.). Other methods for dividing a range of values such as continuous values are also contemplated, for example by dividing the range of continuous values into intervals of equal width, or intervals with equal numbers of rows, or by applying optimal binning operations to determine the division of the range which would yield the greatest separation of y values across the bins.

When defining a depth of interaction for discrete variables, the adaptive sampling system 210 identifies a number of distinct or discrete values. Often, the information needed to define the depth of interaction is available a-priori and it is not necessary to consult the values in the data matrix X (i.e., it is not necessary to read the big data).

Next, when defining a depth of interaction, the adaptive sampling system may identify known constraints on the relationships between the variables in X. In certain embodiments, the constraints can be of the form A1*x1+A2*x2+ . . . +Aq*xq+A0>=0. Defining of these constraints can be important when dealing with “mixtures” in industrial settings (e.g., where the ingredients must sum to 100%) but also elsewhere (e.g., when interested in information about families with five children; the number of boys and girls in each family must be equal to five).

When performing step 330, after variables are selected and the depth of interaction of the variables is defined, (what variables to consider, how complex in terms of interactions should the information be that is to be considered and extracted, and basic information about the numbers of “buckets” or “bins” for each variable), the adaptive sampling system 210 applies optimal experimental design methods. More specifically, the optimal experimental design methods can comprise any operation which constructs a collection of observations which extract the maximum amount of information from the experimental region; these are sometimes referred to as “optimal designs,” “D-Optimal design,” or “A-optimal design,” or else depending on the specific optimization statistic that is chosen by the operator. The optimal experimental design selects the specific observations from all possible or available observations in the raw data, so that given a specific statistical model, the predictions from the model are expected to be of the highest possible accuracy as defined by different statistical criteria based on the expected variance. Specifying an appropriate statistical model and specifying a suitable criterion function both take into account statistical theory and practical knowledge with designing experiments. After the optimal design matrix has been determined, the adaptive sampling system 210 randomly select cases from the big data repository to load into the design matrix, thus creating the sample X′.

In many databases and nonSQL datastores, the process of selecting cases from the big data repository can be performed efficiently by designing appropriate queries to sample specific cases from specific “strata” or “groups. In the present application the sample specific cases are defined through the rows of the optimal design matrix (e.g., select a “male” between the ages (15-17) and “caucasian” . . . ).

Once data are returned to the adaptive sampling system 210, subsequent modeling can then commence against the much smaller sample matrix X′ which contains the maximum amount of information extracted from X with the fewest number of cases.

FIG. 3—This needs to be modified:—Create Optimal Experimental Design in Computation Engine—Transfer this design to Streaming Data. Processing Engine—Extract/store only data consistent with Experimental Design (“look for diagnostic cases”)—Return Data to computational engine to take automated engine, or compute results.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

The claims would need to be modified to be consistent with the new IP.

| | |
|---|---|
| Historical Data at Rest vs. Dynamic Data in Motion | 2 |
| Long-Lived Static Relationships in Historical Data | 2 |
| Short-Lived Dynamically Evolving Patterns in Streaming Data | 3 |
| Extracting Information from Infinite Streaming Data via | 3 |
| Experimental Design | |
| Extracting Information from Data under Time and Resource | 3 |
| Constraints | |
| Experimental Design Methods | 4 |
| Asking Questions of the Data | 5 |
| Experimental Design Matrices | 5 |
| Types of Experimental Design | 7 |
| Summary of Invention: A System for Efficient Information | 7 |
| Extraction from Streaming Data via Experimental Designs | |
| Processing the Streaming Data | 9 |
| Examples | 9 |
| Use Case | 10 |
| A Simple Example | 10 |
| Example of Continuous Streaming Learning with Space Filling- | 10 |
| Design | |
| Example of Continuous Streaming Learning and Space-Filling | 10 |
| Design with Constraints | |
| The ‘681’ Patent | 11 |
| Summary | 11 |

Overview

The proposed invention builds on the recently allowed patent U.S. Ser. No. 10/007,681 (the ‘681 Patent’: Adaptive Sampling via Adaptive Optimal Experimental Designs to Extract Maximum Information from Large Data Repositories. In that patent we proposed to use an adaptive computer system and mechanism to sample from Big Data, selecting only those observations that are most diagnostic with respect to the specific information one wants to extract, or “question one wants to ask” of the big data.

The current invention introduces a system and method to extract information efficiently from streaming data, i.e., data-in-motion. Such data pose specific challenges to analysts seeking to derive useful insights, in particular under conditions of low latency when the rate at which new data are collected preclude detailed analyses based on a moving window of data, or by incrementally updating a machine learning or statistical algorithm. The disclosed system and IP will address this problem by leveraging statistical and experimental design methods to filter new data so that only those observations will be processed in subsequent statistical or machine learning computations that are diagnostic and useful with respect to the analytic problem that is to be solved. In this manner, the system will remain agile and adaptive to new and emerging patterns of relationships in the data, even when the data volume is very large and velocity is very high.

Historical Data at Rest Vs. Dynamic Data in Motion

One consideration when approaching analytic problems based on observed and/or historical data is to evaluate the “useful-life” of the information contained in the data. Specifically, the systematic and repeated relationships and patterns that are contained in the data may be static and invariant, or relatively short-lived. If they are short-lived and/or continuously evolving then analyses of historical data sets are less useful (likely to uncover useful information with respect to the process under investigation), and efficient methods for extracting and updating (recalibrating, re-basing) analytic models must be implemented.

Long-Lived Static Relationships in Historical Data

For example, consider a hypothetical data set summarizing various parameters describing the weather and the average number of visitors to a beach. It is very likely and consistent with common experience that the number of beach goers will vary with weather parameters such as rainfall amount or temperature. In short, there will likely be fewer visitors to a beach in inclement weather when compared to weather conditions generally favorable for beach activities such as swimming or boating. Therefore, historical data sets describing weather conditions will likely be diagnostic of the number of visitors to a beach. Building a prediction model (to predict the number of visitors to a beach from weather conditions) using machine learning or statistical techniques applied to historical data at rest will likely yield prediction models of good accuracy.

In practice there are many domains and applications where relatively stable patterns recorded into historical data sets can be expected to be diagnostic of future observations. For example, consumer credit card spending patterns are likely relatively stable over time, and traditional machine learning models built against historical data sets can yield useful accurate models to predict future spending or detect spending anomalies. Relationships between variables describing nutrition choices or habits and resultant indicators of physical health also can be expected to be stable. There are also many applications in manufacturing where stable patterns of relationships between inputs into a process and resultant product quality are well documented in historical data, and diagnostic of future expected product quality.

Short-Lived Dynamically Evolving Patterns in Streaming Data

In contrast to these examples of relatively stable relationships between variables that can be detected in historical static data sets, consider the often fast changing patterns in data describing consumer fashion preferences or salient voter concerns regarding political issues (“of the day”). In those examples the relationships between predictor variables, and their relationships to the outcome variables of interest (fashion preferences, most important voter concerns) will constantly evolve and change, and the patterns in the data will likely be dynamically unstable.

Such dynamic instability is also common in many complex manufacturing processes involving large numbers of processing steps, for example in chemical or semiconductor manufacturing. In semiconductor manufacturing, the process of reliably creating complex micro-circuitry on silicon wafers requires hundreds of complex processing steps, and 100's of thousands of parameters or more can be associated with quality characteristics of final wafers. Further, in those environments, never-before observed changes in parameters and their interactions can affect final process quality and yield, and such patterns would not be recorded and reflected in historical data.

In these examples and many similar situations historical data sets recording information about data patterns that used to be diagnostic of final process outcomes may no longer be useful for predicting future outcomes. Instead, the specific patterns of relationships between variables are changing and evolving dynamically as data are collected, i.e., streaming from data collection devices or mechanisms (sensors, continuous click-streams, ongoing analyses of Twitter streams, etc.).

Extracting Information from Infinite Streaming Data Via Experimental Designs

The current invention is predicated on the fact that in many modern dynamic data analysis environments and scenarios there are no useful historical data from which diagnostic actionable information and process predictions can be derived. Instead it is often necessary to identify (or “look for”) emerging patterns of relationships between variables in real-time in order to extract useful information that is diagnostic of future observations. Over the past few years there has been increasing interest in analytic algorithms that would dynamically adapt and “learn” as the relationships between variables in the data change; this is often referred to as “concept drift”. However, all of these approaches will inevitably face challenges with respect to scalability and latency, when the numbers of variables that are continuously streaming to the learning algorithm becomes very large, and when the latencies between consecutive observations is very short. In those cases, it becomes impractical if not impossible to update incrementally (as new data points arrive) the complex learning algorithms, to continuously adapt to new or evolving patterns of relationships in the data.

Extracting Information from Data Under Time and Resource Constraints

The core of the disclosed invention describes a computer-based system and method for analyzing high-dimensional (multi-variable) and high-velocity (fast-) streaming data in real time. This system is implements an innovative information-centric approach rather than data-centric approach to data analysis for streaming data: Specifically, instead of processing all data streaming through a continuous data processing system such as TIBCO StreamBase®, the disclosed system will selectively process (filter) particular data points of interest with respect to the information that is to be extracted. Users are provided flexible options to define and modify what constitutes information-of-interest, to introduce constraints with respect to specific combinations of values and value ranges for the available streaming variable values (regions of interest), or to specify other options to define an efficient automatic learning and recalibration (re-basing) process. In short, the user is able to “ask questions of the data stream”, and the system will answer those questions in a highly efficient manner and in real time, performing analytic computations for only the minimum number of observations to answer the question(s) of interest.

Experimental Design Methods

To accomplish this task the system relies on the known science of experimental design methods to select from the continuous data stream the specific data points that are most diagnostic and “useful” in order to answer the specific user-defined analytic questions of interest, or in order to update and recalibrate (“re-base”) existing but dynamically evolving analytic prediction or clustering models.

Experimental design methods were specifically proposed and developed by statisticians and mathematicians in order to address the issue of resource constraints with respect to the effort or cost required to extract information from data via analytic computations. Statistical experimental design methods are widely used in manufacturing in order to select only specific and most informative samples of manufactured product for detailed and sometimes destructive testing. For example, suppose in a complex manufacturing process there are 200 measured variables that may potentially determine (predict) some key final product quality characteristic or performance indicator (KPI). Further, suppose that the measurement of (the process of obtaining data for) those variables as well as final product testing is costly with respect to effort, time, or resources. Under those conditions it is often not practical to test all product that is being manufactured. The task is to identify in the large numbers of units-of-product the smallest number of specific units that are most diagnostic with respect to the relationships among the process inputs, and with final product quality of interest.

In the simplest case and as an example, consider two process input variables A and B, each with two possible levels High or Low, resulting in 4 possible combinations of values for A and B: A-Low and B-Low, A-Low and B-High, A-High and B-Low, and A-High and B-High. Further suppose that a final product quality measurement is taken, and the goal is to identify which specific combination of variable values for A and B is associated with optimal product quality. At a minimum, it is obvious that 4 observations representing each of the 4 possible combinations of values for variables A and B should be randomly chosen. Those 4 observations will allow to extract more information (with respect to the effects of A and B on product quality) than, for example, 1000 observations tested at levels A-Low and B-High or A-High and B-Low. Even though more observations would be tested in the latter case it would be logically impossible to separate the effects of A and B on final product quality. This simplified example demonstrates why and how targeted sampling (or filtering and “looking-for” specific observations in streaming data) can yield more information with much greater efficiency, compared to simply processing (updating-of-models based on) all data streaming through a computer system.

Asking Questions of the Data

In general, the theory and mathematics of Experimental Design allows to “ask questions of data” by providing detailed guidance to determine a-priori (without having actually analyzed any data) what specific combinations of variable values need to be sampled (and processed in subsequent computations) in order to derive the maximum amount of information from the data with respect to the questions (hypotheses) of interest. These methods can also be used in order to specifically extract (“query”) specific experimental “regions-of-interest”, i.e., combinations of value ranges for specific variables in order to assess the effects of variables and their interactions in the specified region-of-interest, or to build prediction models for those specific regions in the input variable space. The illustration below shows a user interface using sliders to specify such a region-of-interest.

Experimental Design Matrices

The specific observations that are selected for analyses are prescribed by a so-called experimental design matrix, i.e., a matrix of specific combinations of data values for the input variables of interest that should be queried from the data or selected from the continuous data stream in order to answer specific questions about the impact of the variables on some outcome variable of interest. The table below shows a simple example of an experimental design matrix with variables Soil Condition, Potsize, Variety, Production Method, and Location.

| 1 | | | 4 | |
|---|---|---|---|---|
| SOIL | 2 | 3 | PRODUCTION | 5 |
| CONDITION | POTSIZE | VARIETY | METHOD | LOCATION |
| Field | Three | Bonny | Flat | A |
| Field | Four | Marglobe | Flat | A |
| Plus | Three | Marglobe | Flat | A |
| Plus | Four | Bonny | Flat | A |
| Field | Three | Bonny | Fibre | C |
| Field | Four | Marelobe | Fibre | C |
| Plus | Three | Marglobe | Fibre | C |
| Plus | Four | Bonny | Fibre | C |
| Field | Three | Bonny | FibrePl | B |
| Field | Four | Marglobe | FibrePl | B |
| Plus | Three | Marglobe | FibrePl | B |
| Plus | Four | Bonny | FibrePl | B |
| Field | Three | Marglobe | Flat | B |
| Field | Four | Bonny | Flat | B |
| Plus | Three | Bonny | Flat | B |
| Plus | Four | Bonny | Flat | B |
| Field | Three | Bonny | Fibre | A |
| Field | Four | Bonny | Fibre | A |
| Plus | Three | Bonny | Fibre | A |
| Plus | Four | Bonny | Fibre | A |
| Field | Three | Bonny | FibrePl | C |
| Field | Four | Bonny | FibrePl | C |
| Plus | Three | Bonny | FibrePl | C |
| Plus | Four | Bonny | FibrePl | C |
| Field | Three | Bonny | Flat | C |
| Field | Four | Bonny | Flat | C |
| Plus | Three | Bonny | Flat | C |
| Plus | Four | Bonny | Flat | C |
| Field | Three | Bonny | FibrePl | A |
| Field | Four | Bonny | FibrePl | A |
| Plus | Three | Bonny | FibrePl | A |
| Plus | Four | Bonny | FibrePl | A |
| Field | Three | Bonny | Fibre | B |
| Field | Four | Bonny | Fibre | B |
| Plus | Three | Bonny | Fibre | B |
| Plus | Four | Bonny | Fibre | B |

According to statistical theory, when those specific data points are randomly chosen from the data stream (or are streaming in random order to the data processing engine), then the confidence with which analytic models can be estimated and predictions can be made will depend only on the number of data points that are sampled, and not the total number of data points that are available.

In summary, an experimental design matrix is a matrix of data values for input variables identifying the specific data points with specific combinations of variable values that should be considered (sampled) for subsequent computations, in order to answer specific analytic questions or build specific analytic prediction models. The Experimental Design matrix contains the prescription for what data points to process in subsequent analytic computations in order to extract the maximum amount of relevant information with the minimum amount of computational effort and cost, i.e., analytic processing of the minimum numbers of actual data points. In short, Experimental Design Matrices can provide the guidance for how to obtain the fastest answer to specific questions asked about relationships between variables in the data.

Types of Experimental Design

There are a large number of different types of experimental designs described in the literature to address different analytic questions (e.g., linear models, non-linear models, models with or without interactions, etc.) for different types of variables (e.g., continuous, discrete). In addition, a class of experimental designs called “space-filling-designs” describes methods that are suitable when there are no specific expectations regarding the nature of the (linear or nonlinear) relationships between variables. Space-filling designs are often used in automated computer experiments in order to ensure equal spacing of observations over the entire input “space”, defined by the value ranges of the variables (the “inputs”) of interest.

Summary of Invention: A System for Efficient Information Extraction from Streaming Data Via Experimental Designs

To summarize, the invented system and method describes a computer analysis system for streaming data that will efficiently extract relevant information by processing only selected data points, namely those considered most diagnostic with respect to the information of interest (the “questions” that are asked). This system consists of three major components:
1. A Streaming Data Processing Engine that processes the continuous data stream of possible large numbers of potential predictor variables; for example TIBCO StreamBase® is such a system,
2. An Experimental Design and Deployment engine such as TIBCO Statistica® for generating and deploying (for sampling/filtering) experimental design matrices, i.e., data matrices identifying the specific data points of interest for subsequent data processing; those data matrices can be used by the Streaming Data Processing Engine to select/query the specific diagnostic points of interest from the continuous data stream,
3. Analytics and/or Visualization Engine such as TIBCO Statistica® or TIBCO Spotfire® Data Streams that will continuously process the selected data points as they are selected by the Streaming Data Processing Engine, generating or update predictive models and related statistics such as variable importance values with respect to the fitted prediction models.

The Streaming Data Processing Engine can enumerate the dimensions and value ranges (mins, max; or numbers of discrete values) in each of the user-selected variables in the streaming data; those possible value ranges or discrete values for the selected variables can also be manually specified by the user. This information is provided to an Experimental Design and Deployment Engine (e.g., TIBCO Statistica®) in order to generate an Experimental Design Matrix consistent with other user-defined choices and constraints, to allow for the estimation of main-effects, interactions to a user-specified degree, linear and nonlinear effects, etc. from a minimum number of continuously updating selected observations. The Experimental Design and Deployment Engine creates an experimental design based on user-defined inputs that identify the available variables to be considered (those for which data are collected and streaming through the Streaming Data Processing Engine). In addition, the user can request
Whether or not a space-filling or optimal design should be generated
The total number of observations that are to be queried from the continuous data
Further details about the specific characteristics of the experimental design, such as but not limited to:
   The specific type and properties of the space-filling design to be generated (for space-filling designs)
   The specific numbers of levels to be considered in continuous or discrete variables
   Whether or not interaction effects are to be considered, and if so, to which degree (e.g., two-way interactions, three-way interactions, etc.; for Optimal Experimental Designs)
   Whether or not simplified (very-fast) computations should be enabled through the use of so-called “orthogonal designs”, i.e., designs where the columns of the experimental design matrix are mutually independent of each other (see for example https://en.wikipedia.org/wiki/Design of experiments).
Whether or not specific main effects and/or interaction effects are to be un-confounded, i.e., whether the effect of specific variables or variable interactions is to be statistically estimable without confounding with other variable or variable interaction effects (for Optimal Experimental Designs)
Whether or not overall goodness-of-model-fit testing shall be possible (for Optimal Experimental Designs)
Whether or not certain constraints need to be considered with respect to certain combinations of variable values that are not possible and cannot be observed in the streaming data; for example, a mixture constraint might specify that the sum of all variable values must be constant (for Optimal Experimental Designs); other constraints may specify upper and lower bounds for combinations of variable values
If replicated observations at specific points (combinations of input variables) are to be sampled, and if so, how many.
If sliding data windows are to be maintained at the points of the experimental design (for each combination of input variables), how wide the sliding data window should be; during continuous streaming data analyses, when a specific combination of input variables is sampled (as consistent with the experimental design), the system will then replace the oldest data points for each combination of input variables with the most recent and newly sampled point.
In the process described in the previous paragraph, users can specify an additional parameter value to define the minimum time difference between the oldest selected data point and the most recent selected data point with identical combinations of values for the input variables (i.e., observations consistent with the identical row in the experimental design matrix); the system will only replace a data point and update the analytic computations if the time difference between the oldest and most recent selected data point is greater than the user-defined time-difference values.
Additional rules and weights specifying certain numbers of replications for certain combination of input variables or groups of such combinations of input variables (regions of interest); such rules or weights will cause the specific combinations of input variables or groups of such combinations to be sampled with more replications (more observations), for example, in order to allow for the estimation (building) of prediction models with greater accuracy in the specified regions of interest.

The Computational Engine will then generate the appropriate experimental design matrix based on known optimal or space-filling experimental design methods, i.e., the specific matrix of variable values that are to be sampled from the continuous data stream. That matrix will be used by the Streaming Data Processing Engine in order to select/filter specific points of interest from the continuous data stream, i.e., those that are instances of specific combinations of variable values contained in (prescribed by) the experimental design matrix.

Processing the Streaming Data

As the data for the selected variables stream through the Streaming Data Engine, and when data points that are consistent with the Experimental Design Matrix are encountered, those data points are then selected and processed by an Analytics Engine such as TIBCO Statistica® and/or Visualization Engine such as TIBCO Spotfire® Data Streams. In that process, other user-selections as described above are also implemented, e.g., multiple (replicated) data points can be sampled for all or specific combinations of variable values, or sliding-data-windows are maintained for all or specific combinations of variable values, so that historically older observations are replaced with historically more recent observations.

### EXAMPLES

The following paragraphs describe simple examples of how the disclosed system and method can be used to implement an efficient and automatic learning or modeling mechanism with streaming data.

Use Case

The use cases where the disclosed system can provide significant value can be found across multiple domains where relatively short-lived relationships between variables determine important outcome variables. Such examples might be (but are not limited to):
In manufacturing, where continuous data streams report on the continuous operation of tools and machines involved in an automated manufacturing process, or in a continuous manufacturing process, such as semiconductor manufacturing or chemical manufacturing; In marketing, where continuous data streams report on the continuous interactions between customers with a commerce website;
In financial services, where continuous data streams report on the continuous processing of financial transactions of different types, the amounts of money involved, and other metadata associated with the respective transactions;
In insurance services, where continuous data streams report on the continuous processing of insurance claims and the various characteristics and properties of the claims and claimants.

### A Simple Example

For example, if a product quality characteristic is being monitored as a function of 200 variables defined in the Experimental Design Matrix, then simple computations can be performed to estimate the importance or predictive power of each variable for the prediction of product quality, and the results can be rendered in a Pareto chart. That chart would show and continuously update the importance of each variable or their interactions for product quality. Thus, the system would provide an efficient and practical continuous view of current and emerging patterns detected in the streaming data, as the data stream through the Streaming Data Engine.

### Example of Continuous Streaming Learning with Space Filling-Design

As another example, a space-filling design could be specified, along with replications at specific regions of interest of the input space and a sliding data window. As the Streaming Data Engine identifies and selects combinations of variables consistent with the experimental design, those data points are then sent to the Analytics and Visualization Engine, which updates a prediction model of some outcome of interest (e.g., updates the prediction of risk with respect to equipment failure). As the streaming data processing continuous, when a new observation consistent with a point prescribed by the space-filling design is identified and selected, the respective prediction model will be re-estimated based on the most recent data window (recalibration, or re-basing of models). In this manner, an efficient and scalable adaptive analysis learning engine to predict equipment failure can be continuously updated as new diagnostic (informative) data points are observed.

### Example of Continuous Streaming Learning and Space-Filling Design with Constraints

As another example, a space-filling design could be specified along with specific constraints with respect to the experimental design region of interest (constraints with respect to specific combinations of values for the input variables). Those constraints could be specified using a user interface with sliders as depicted in the previous figure. The Streaming Data Engine will then identify the specific data points consistent with the experimental design for the constrained experimental design region, and send those data points to the Analytics and Visualization Engine to compute or recalibrate a prediction model (e.g., for the Proportion of cases with overtakes, as shown in the Figure). As the data continue to stream, the user can update the specific constraints using the slider interface, causing the space-filling design to be updated, causing in turn different data points to be filtered by the Streaming Data Engine, and updated models to be computed or recalibrated.

These are just three simple examples of how the disclosed system and method can operate in order to accomplish specific analytic tasks and efficient learning from streaming data.

The ‘681’ Patent

The current proposal is related to the allowed 681 patent describing a computer system for analyzing data in large (near or actually infinite) Big-Data stores, when it is not practical or desirable to look at all data. Given the desire to identify quickly and while operating under various resource constraints the specific parameters and their interactions that are important in the prediction of one or more outcomes, a computer system may only extract and analyze a very small sample of specifically selected observations to provide the answer, with known confidence bounds. Further, regardless of how large the data repository is, the computational effort and other resources (e.g., to move data) only depend on the specific parameters and parameter interactions one wants to detect and evaluate: The accuracy of results from samples is determined by the sample size and sample characteristics, and not by the population (Big-Data) size. The current disclosure specifically extends and further refines this approach to the analysis of streaming data, describing an effective and scalable system and method to continuously update insights and results from high-speed low-latency high-dimensional streaming data. The disclosed system will enable efficient information extraction in a high-performance streaming analytics system, by implementing the Experimental Design method and system as described.

### SUMMARY

To summarize, the disclosed invention is about the efficient extraction of information from data streams under time and resource constraints. The general goal is to extract the maximum amount of information in the least amount of time with the smallest (computing, and other) resources. That is the core value of the disclosed IP. The approach is similar to the recently allowed 681 patent, where a computer system applying optimal experimental design methods is proposed for this purpose in the context of Big Data analytics. The present application introduces numerous new disclosures specifically related to the application of experimental design methods to streaming data. In the present disclosure, a system and method is described that leverages experimental designs and filtering of data points (consistent with the experimental designs) to select only those observations for subsequent analytic processing or visualization that are known a-priori (based on the experimental design) to provide the greatest amount of new information with respect to the variables of interest. The system is innovative in that it does not rely on the processing of all streaming data to estimate and update (recalibrate) predictive, machine learning, or statistical models, but only a small selection of data points, namely those that are most diagnostic with respect to the questions asked of the data. Thus, the disclosed system will greatly increase the scalability of real-time analytics systems applied to streaming data because it intelligently and based on statistical principals selects only those observations for subsequent analytic modeling that are most diagnostic with respect to the questions of interest and asked of the data. This system further provides a flexible user interface and advanced computing architecture to enable various refinements of specific input regions of interest, analytic models of interest, and other characteristics pertaining to the questions to be asked of the data.

What is claimed is:

1. A computer-implementable method for identifying information within a data repository, comprising:
selecting variables of interest within the data repository to provide selected variables;
defining a depth of interactions of interest with respect to the variables of interest to provide a defined depth of interactions;
applying an optimal experimental design operation to the selected variables and the defined depth of interactions, the applying providing returned data based upon the optimal experimental design operation; and
performing operations on the returned data, the returned data providing a sample matrix of the data repository.

2. The method of claim 1, wherein: defining the depth of interactions that are of interest further comprises determining whether to only consider information that can be extracted using each variable of interest.

3. The method of claim 1, wherein: defining the depth of interactions that are of interest further comprises determining whether to consider certain interactions of the variables of interest.

4. The method of claim 3, wherein: the certain interactions comprise at least one of two-way interactions and multiplications of two design vectors based upon the variables.

5. The method of claim 1, wherein: defining the depth of interactions that are of interest further comprises determining types of variables to consider, the types of variables being identified as continuous variables, rank-ordered variables and discrete variables.

6. The method of claim 1, wherein: defining the depth of interactions that are of interest further comprises identifying known constraints on relationships between the variables of interest.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
selecting variables of interest within the data repository to provide selected variables;
defining a depth of interactions of interest with respect to the variables of interest to provide a defined depth of interactions;
applying an optimal experimental design operation to the selected variables and the defined depth of interactions, the applying providing returned data based upon the optimal experimental design operation; and
performing operations on the returned data, the returned data providing a sample matrix of the data repository.

8. The system of claim 7, wherein: defining the depth of interactions that are of interest further comprises determining whether to only consider information that can be extracted using each variable of interest.

9. The system of claim 7, wherein: defining the depth of interactions that are of interest further comprises determining whether to consider certain interactions of the variables of interest.

10. The system of claim 9, wherein: the certain interactions comprise at least one of two-way interactions and multiplications of two design vectors based upon the variables.

11. The system of claim 7, wherein: defining the depth of interactions that are of interest further comprises determining types of variables to consider, the types of variables being identified as continuous variables, rank-ordered variables and discrete variables.

12. The system of claim 1, wherein: defining the depth of interactions that are of interest further comprises identifying known constraints on relationships between the variables of interest.

13. A non-transitory, computer-readable storage medium embodying computer program code, the computer program code comprising computer executable instructions configured for:
selecting variables of interest within the data repository to provide selected variables;
defining a depth of interactions of interest with respect to the variables of interest to provide a defined depth of interactions;
applying an optimal experimental design operation to the selected variables and the defined depth of interactions, the applying providing returned data based upon the optimal experimental design operation; and
performing operations on the returned data, the returned data providing a sample matrix of the data repository.

14. The non-transitory, computer-readable storage medium of claim 13, wherein: defining the depth of interactions that are of interest further comprises determining whether to only consider information that can be extracted using each variable of interest.

15. The non-transitory, computer-readable storage medium of claim 13, wherein: defining the depth of interactions that are of interest further comprises determining whether to consider certain interactions of the variables of interest.

16. The non-transitory, computer-readable storage medium of claim 15, wherein: the certain interactions comprise at least one of two-way interactions and multiplications of two design vectors based upon the variables.

17. The non-transitory, computer-readable storage medium of claim 13, wherein: defining the depth of interactions that are of interest further comprises determining types of variables to consider, the types of variables being identified as continuous variables, rank-ordered variables and discrete variables.

18. The non-transitory, computer-readable storage medium of claim 13, wherein: defining the depth of interactions that are of interest further comprises identifying known constraints on relationships between the variables of interest.
